(19) United States
(12) Patent Application Publication
(10) Pub. No.: US 2005/0061127 A1
(43) Pub. Date: Mar. 24, 2005

(54) Device for dispensing a paper product

(76) Inventor: Kazmier J. Kasper, Hopkinton, MA (US)

Correspondence Address: KRIEGSMAN & KRIEGSMAN, 665 Franklin Street, Framingham, MA, 01702, US

(21) Appl. No.: 10/884,630

(22) Filed: Jul. 2, 2004

Related U.S. Application Data
(60) Provisional application No. 60/487,124, filed on Jul. 14, 2003.

(51) Int. Cl. B26D 5/20; B26D 1/18

(52) U.S. Cl. 83/488; 83/614; 83/202

(57) ABSTRACT

A device for feeding and cutting a paper product includes a motor-driven feed mechanism for indexing the paper product into the device and a motor-driven cutting mechanism for creating a linear cut in the paper product at a user-specified location in from its leading edge. The feed mechanism includes a pair of upper feed rollers and a single lower feed roller which frictionally contact opposite sides of the paper product. The cutting mechanism includes a pair of platens which are disposed on opposite sides of the paper product. In addition, the cutting mechanism includes an instrument for creating the linear cut in the paper product. The instrument includes a cutting block which is slidably mounted on a pair of horizontally disposed rods, a sharpened knife blade affixed to the cutting block and a wheel which is rotatably mounted on the cutting block. In use, as the cutting block is driven along the horizontal rods, the wheel rolls on top of the upper platen which, in turn, sandwiches the paper product tightly between the pair of platens. With the paper product held taut and secured in place between the pair of platens, displacement of the cutting block causes the sharpened tip of the knife blade to cleanly cut the paper product along a linear path.

### CROSS-REFERENCE TO RELATED APPLICATIONS

The present application claims the benefit under 35 U.S.C. 119(e) of U.S. provisional Patent Application Ser. No. 60/487,124, filed Jul. 14, 2003, the disclosure of which is incorporated herein by reference.

### BACKGROUND OF THE INVENTION

The present invention relates generally to systems for dispensing products and more specifically to systems for dispensing paper products.

Paper products are commonly manufactured into an elongated, continuous supply (e.g., a web) which, in turn, is wound onto a roll for ease in transport and storage. The continuous supply of the paper product can then be cut at specified locations to produce a plurality of individual paper products.

Systems for dispensing a plurality of individual paper products from a continuous supply are well known in the art. Such a system typically includes motor-driven feed means for indexing the continuous supply of the paper product into the system. The system also typically includes cutting means for severing the continuous supply at specified locations so as to yield a plurality of individual paper products. The system further typically includes motor-driven dispensing means for ejecting each of the individual paper products out from the system.

As an example, systems of the type described above are commonly used to dispense instant lottery tickets. Lottery ticket dispensing machines typically store within its housing a continuously-connected supply of tickets, each ticket being manufactured out of paper or cardboard. Commonly, the continuous supply of tickets is stored in a fanfold form with adjacent tickets being connected through a line of perforation.

Prior to being dispensed, each ticket must be separated by the machine from the remainder of tickets in the continuous supply. Presently, numerous methods exist in which a dispensing machine separates an individual ticket from a continuous supply.

In a first method, individual tickets are cut apart prior to dispensing using a knife edge or other similar severing instrument.

Although well-known in the art, it has been found that this first method suffers from a notable drawback. Specifically, the individual ticket to be separated from the remainder of the supply is often inadequately supported during the severing process. As a consequence, the ticket often wrinkles, bends and/or creases during the cutting stroke which, in turn, can compromise the accuracy and effectiveness of the cut, which is highly undesirable.

In a second method, individual tickets are burst, rather than cut, apart prior to dispensing. Specifically, a burster wheel having a cylindrical contact surface separates the leading ticket from the next following ticket along a line of weakness therebetween instead of cutting the two tickets apart. The burster wheel is in the form of a circular burster blade which has a dull rounded edge that does not cut the stream of tickets but rather exerts pressure against the top of the stream of tickets to deflect the tickets and separate them along the line of weakness separating the tickets.

For example, in U.S. Pat. No. 5,836,498 to E. F. Turek, there is disclosed a lottery ticket dispenser which includes a burster wheel having a cylindrical contact surface. The improved burster wheel provides for an increased range of operation so that greater misalignment between the perforation or line of weakness between adjacent tickets in a fanfold stream and the path of the burster wheel can be accommodated while still providing a reliable and effective separation of the adjacent tickets along the line of weakness.

Although well-known in the art, this second method suffers from a notable drawback. Specifically, the second method can only be used to separate tickets which include a line of weakness, such as a perforation line, therebetween. To the contrary, this second method can not be used to cut other types of paper products which are not manufactured with a line of weakness. As a consequence, this second method is limited in its range of potential applications, which is highly undesirable.

### SUMMARY OF THE INVENTION

It is an object of the present invention to provide a novel device for dispensing a paper product.

It is another object of the present invention to provide a device of the type described above which accurately and cleanly separates a length of the paper product from a continuous supply.

It is yet another object of the present invention to provide a device as described above which includes a limited number of parts, which is easy to use and which is inexpensive to manufacture.

Accordingly, there is provided a device for feeding and cutting a product, said product having a top surface, a bottom surface and a leading edge, said device comprising a feed mechanism for indexing said product, and a cutting mechanism for severing said product, said cutting mechanism comprising, a cutting device adapted to sever said product, a first platen having a top surface and a bottom surface, a second platen having a top surface and a bottom surface, said first platen and said second platen together defining a product exit channel therebetween.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a front, top perspective view of a device for feeding and cutting a paper product, said device being constructed according to the teachings of the present invention;

FIG. 2 is a front, left side perspective view of the device as shown in FIG. 1;

FIG. 3 is a front, right side perspective view of the device as shown in FIG. 1;

FIG. 4 is a top perspective view of the device as shown in FIG. 1;

FIG. 5 is an enlarged, fragmentary, top perspective view of the device as shown in FIG. 1;

FIG. 6 is a rear, top perspective view of the device as shown in FIG. 1;

FIG. 7 is a rear, left side perspective view of the device as shown in FIG. 1;

FIG. 8 is a rear, right side perspective view of the device as shown in FIG. 1;

FIG. 9 is a front perspective view of the device as shown in FIG. 1, the device being shown with a paper product fed thereinto;

FIG. 10 is a rear perspective view of the device as shown in FIG. 9, the device being shown prior to one cutting stroke of the cutting mechanism;

FIG. 11 is a rear perspective view of the device as shown in FIG. 9, the device being shown during one cutting stroke of the cutting mechanism; and

FIG. 12 is a rear perspective view of the device as shown in FIG. 9, the device being shown after one cutting stroke of the cutting mechanism.

### DETAILED DESCRIPTION OF THE PREFERRED EMBODIMENT

Referring now to the drawings, there is shown a device 11 for feeding and cutting a paper product 13, device 11 being constructed according to the teachings of the present invention. As will be described further in detail below, device 11 is adapted to extract paper product 13 and, in turn, sever paper product 13 along a pre-defined linear path, which is highly desirable.

It should be noted that, for simplicity purposes only, device 11 is described herein in conjunction with feeding and cutting a paper product 13. However, it is to be understood that device 11 is not limited for use with a product constructed out of paper. Rather, device 11 could be used to feed and cut products manufactured out of other types of similar materials, such as thin, severable sheets of cardboard, plastic or metal, without departing from the spirit of the present invention.

Device 11 comprises a support 15, a feed mechanism 17 mounted on support 15 for extracting, or pulling, paper product 13, a cutting mechanism 19 for accurately severing paper product 13 along a linear, user-specified path, and electronic circuitry 21 for controlling the operation of feed mechanism 17 and cutting mechanism 19.

Support 15 serves as the structural foundation for device 11. Accordingly, support 15 is preferably constructed out of a rigid, durable and strong material, such as metal. Support 15 preferably comprises a flat base 23 onto which the remainder of device 11 is mounted. A pair of elongated, spaced apart support bars 25-1 and 25-2 are fixedly mounted onto base 23 by screws along its front and rear edges, respectively. In addition, a pair of flat, spaced apart plates 27-1 and 27-2 are fixedly mounted onto base 23 by screws along its left and right edges, respectively. Furthermore, a pair of L-shaped brackets 29-1 and 29-2 are fixedly mounted onto plates 27-1 and 27-2, respectively, by screws. Together, base 23, support bars 25, plates 27 and brackets 29 serve to support feed mechanism 17, cutting mechanism 19 and electronic circuitry 21, as will be described further in detail below.

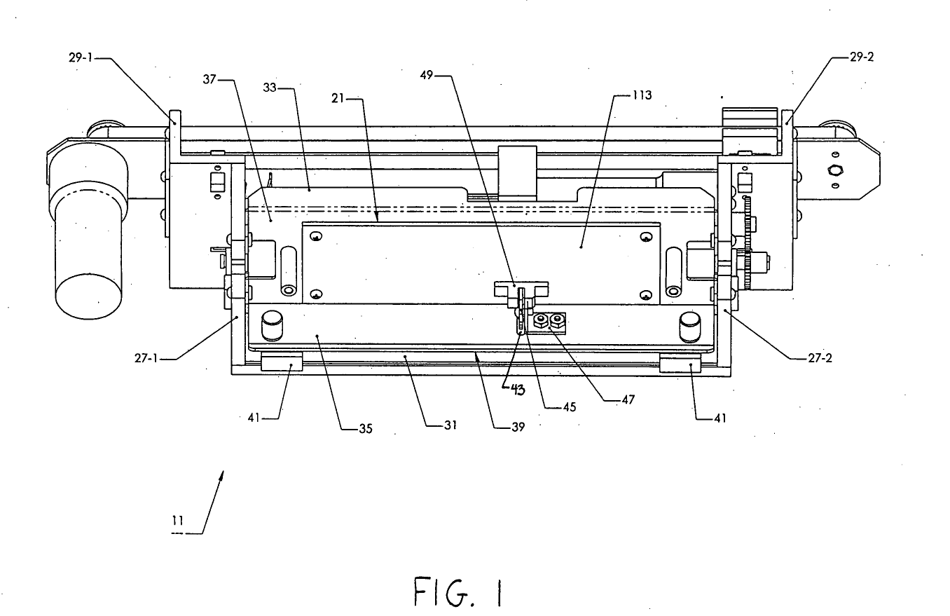

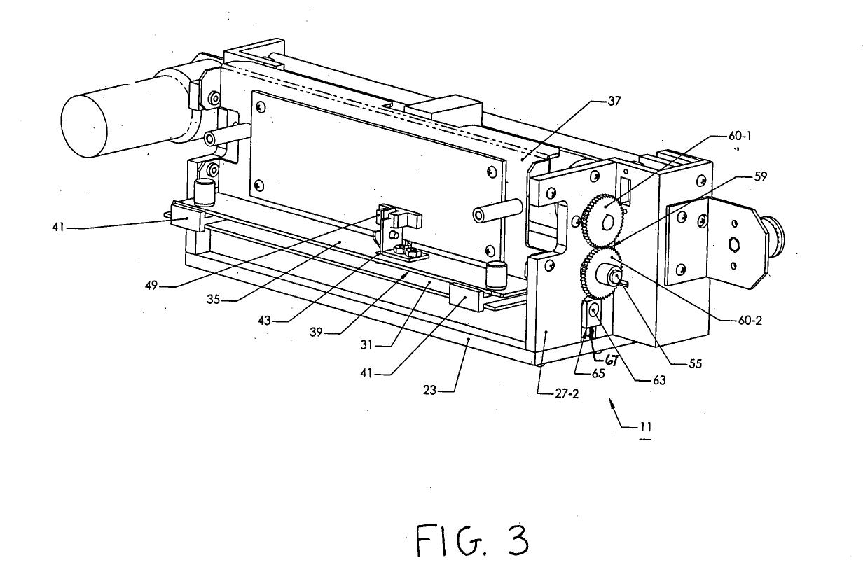

As seen most clearly in FIGS. 1-3, feed mechanism 17 comprises a flat, horizontally disposed support plate 31 which is fixedly secured onto the free end of support bar 25-1. Further, a plate 33 extends laterally between plates 27 and is secured thereto by screws. Plate 33 is an integral member which includes a substantially flat horizontal portion 35 and a substantially flat vertical portion 37. It should be noted that horizontal portion 35 of plate 33 is disposed spaced slightly above plate 31 so as to define a narrow paper entry channel 39 therebetween. As will be described further below, paper product 13 is fed into device 11 through paper entry channel 39. Preferably, a pair of spaced apart guiding blocks 41 are disposed between horizontal portion 35 of plate 33 and plate 31 on opposite ends of paper entry channel 39 to facilitate in the process of guiding paper product 13 into device 11.

It should be noted that horizontal portion 35 of plate 33 is preferably provided with a narrow slot 43. Further, a finger 45 is pivotally mounted onto horizontal portion 35 by a bracket 47. Finger 45 is structurally configured to naturally pivot such that a first end 45-1 of finger 45 extends down into slot 43 and a second end 45-2 of finger 45 extends within the slot of a sensor 49 which is electrically connected to circuitry 21.

As can be appreciated, in the absence of paper product 13 being loaded into device 11, first end 45-1 of finger 45 is free to pivot downward into slot 43 which, in turn, pivots second end 45-2 of finger 45 within the detection zone (i.e., the slot) of sensor 49. As a result, sensor 49 passes a signal to electronic circuitry 21 which, in turn, can notify the user that paper needs to be loaded into device 11. To the contrary, with paper product 13 properly loaded into device, paper product 13 limits the degree in which first end 45-1 of finger 45 can pivot downward into slot 43 which, in turn, pivots second end 45-2 of finger 45 outside of the detection zone of sensor 49. As a result, sensor 49 will not pass a signal to circuitry 21 to load more paper into device 11.

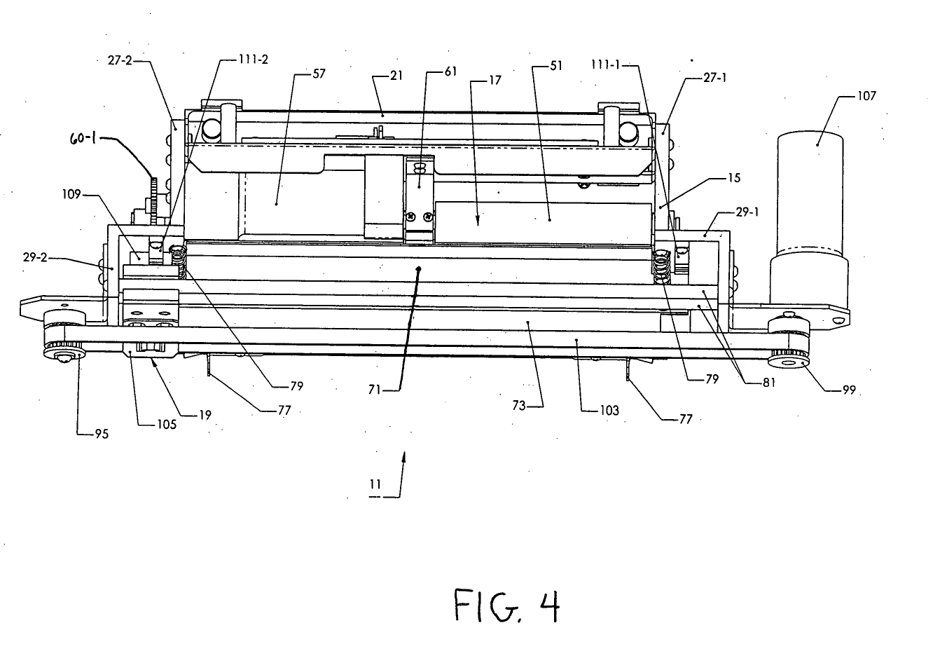

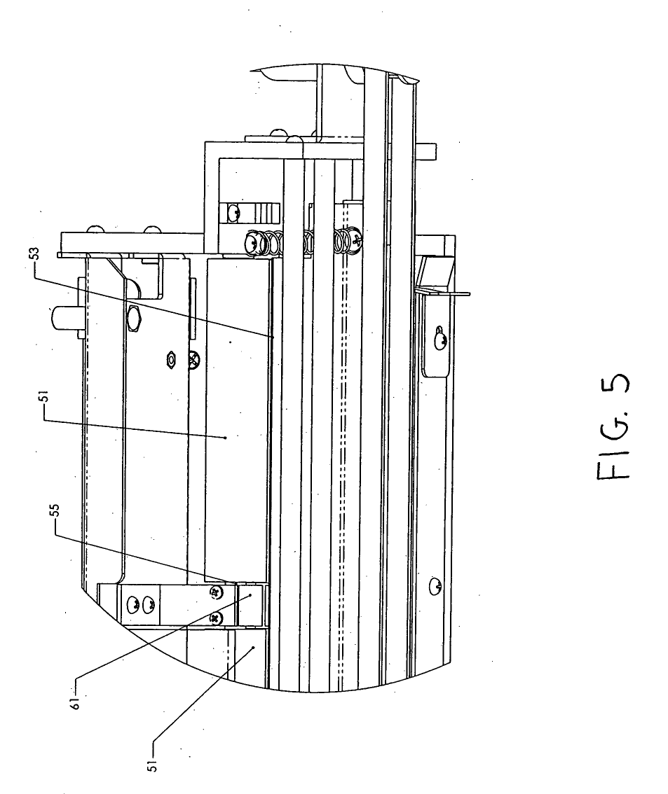

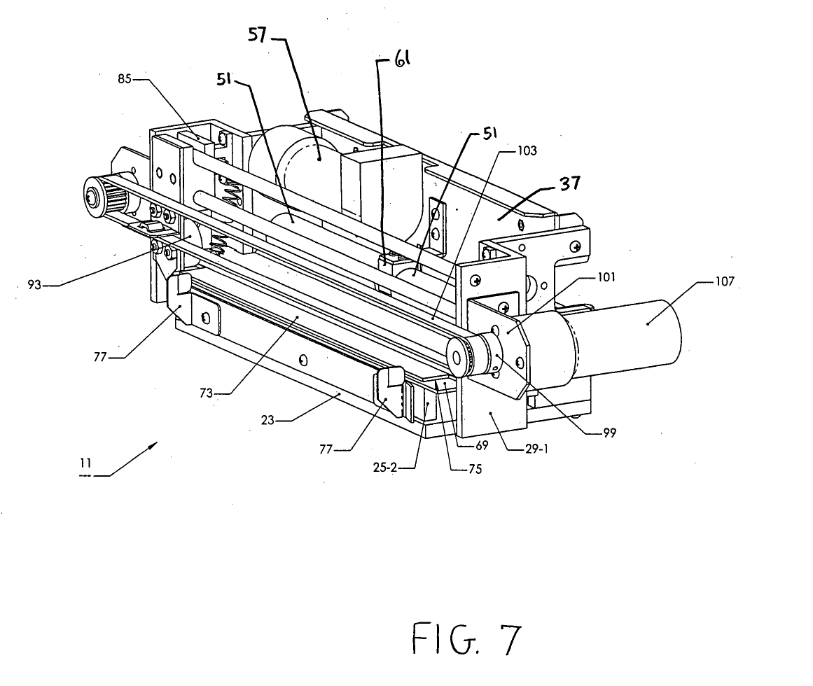

As seen most clearly in FIGS. 4, 5 and 7, feed mechanism 17 additionally comprises a pair of upper feed rollers 51 and an elongated lower feed roller 53, upper feed rollers 51 being disposed directly above lower feed roller 53. As will be described further below, upper and lower feed rollers 51 and 53 together act to extract (i.e., feed) paper product 13 (which has been inserted in through paper entry channel 39) into device 11.

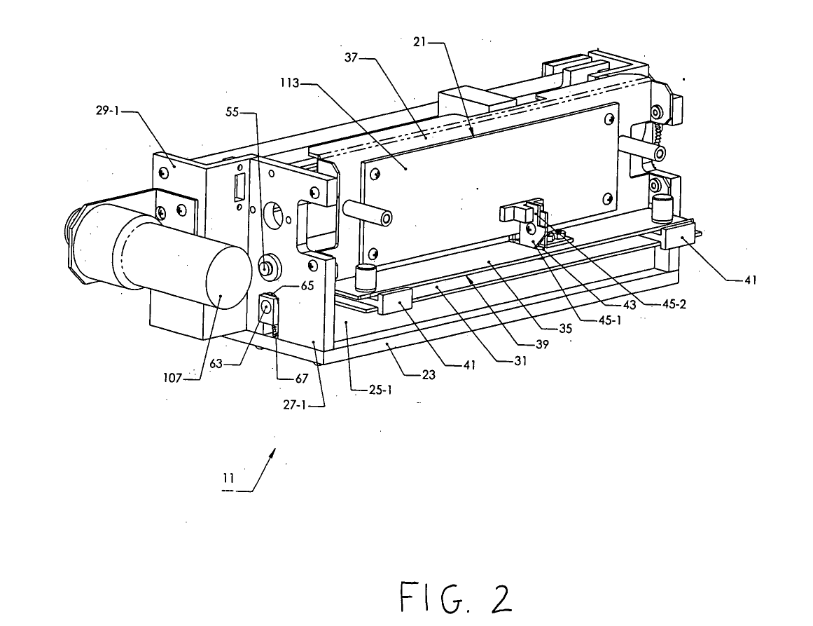

As seen most clearly in FIGS. 2, 3, 4 and 7, upper feed rollers 51 are fixedly mounted onto an axle 55 which extends laterally between plates 27-1 and 27-2. A motor 57 electrically connected to circuitry 21 is mounted onto right plate 27-2 and is coupled to axle 55 through a gear assembly 59. Specifically, a first gear 60-1 is fixedly mounted onto the main axle for motor 57. Similarly, a second gear 60-2 is fixedly mounted onto axle 55, second gear 60-2 being disposed into constant engagement with first gear 60-1. In this manner, activation of motor 57 by circuitry 21 causes first gear 60-1 to rotate which, in turn, causes second gear 60-2 to rotate. The rotation of second gear 60-2 serves to rotatably drive upper feed rollers 51 which, in turn, feeds any paper product 13 wedged between upper and lower feed rollers 51 and 53.

It should be noted that upper feed rollers 51 are spaced slightly apart on axle 55. An optical sensor 61 is fixedly mounted onto vertical portion 37 of plate 33 and is disposed to project between upper feed rollers 51. As will be described further in detail below, sensor 61 is used to detect the leading edge 13-1 of paper product 13 as it is being fed into device 11. In this manner, electronic circuitry 21 can accurately control the precise location in from leading edge 13-1 where cutting mechanism 19 executes a linear cut, as will be described further in detail below.

Lower feed roller 53 is mounted onto an axle 63 which extends laterally between plates 27-1 and 27-2. Lower feed roller 53 functions as an idler roller for feed mechanism 17.

It should be noted that plates 27-1 and 27-2 are each provided with a vertical slot 65 which allows for the vertical displacement of axle 63 and, in turn, lower feed roller 53, axle 63 being biased vertically upward at its free ends by a pair of compression springs 67. In this manner, lower feed roller 53 is resiliently biased vertically upward and into contact with the underside of paper product 13. At the same time, lower feed roller 53 is capable of being urged vertically downward to accommodate paper products 13 of increased thickness, which is highly desirable.

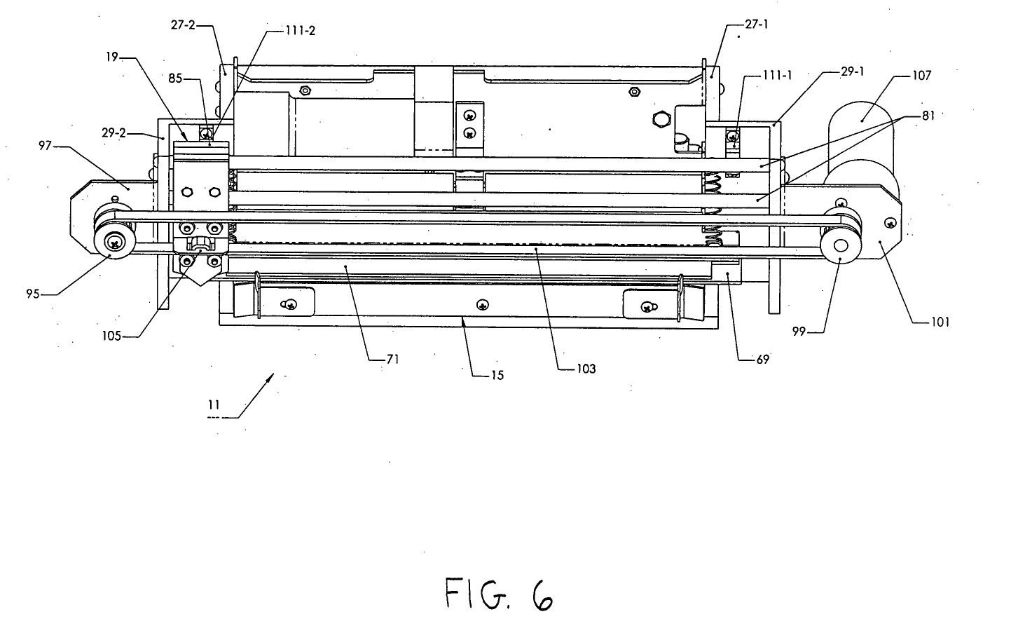

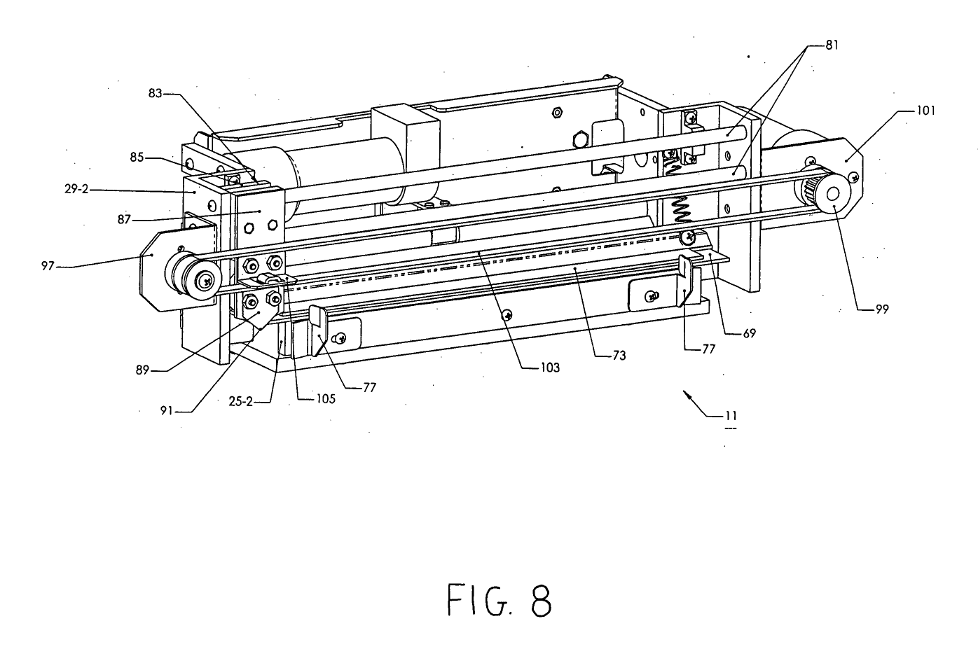

As seen most clearly in FIGS. 4 and 6-8, cutting mechanism 19 comprises a flat horizontally disposed platen 69 which is fixedly secured onto the free end of rear support bar 25-2 by screws. In addition, a bracket 71 extends laterally and is coupled, at each end, to L-shaped brackets 29 using slot-tab connection means. Bracket 71 includes a substantially flat, horizontally disposed platen 73 which is disposed spaced slightly above platen 69. Together, platen 73 and platen 69 define a narrow paper exit channel 75 therebetween. A pair of tabs 77 are coupled to the rear surface of rear support bar 25-2 to the maintain proper alignment of paper product 13 as it exits device 11.

It should be noted that bracket 71 is pivotally coupled to brackets 29, as seen most clearly in FIG. 4. A pair of springs 79 serve to resiliently pivot platen 73 away from platen 69 to enable paper product 13 to pass freely through paper exit channel 75, each spring 79 being coupled, at one end, to bracket 29 and, at the other end, to bracket 71.

Cutting mechanism 19 additionally comprises a pair of spaced apart rods 81, which extend horizontally between brackets 29 and which are secured thereto by screws, and a cutting device 83 which is mounted for translation along rods 81.

Specifically, cutting device 83 comprises a cutting block 85 which is slidably mounted on rods 81. A flat metal plate 87 is fixedly mounted onto the rear surface of cutting block 85. A knife blade 89, in turn, is fixedly mounted onto the rear surface of plate 87. Knife blade 89 comprises a V-shaped cutting tip 91, both edges of V-shaped tip 91 being sharpened to cut paper product 13. As will be described further below, cutting device 83 is constructed to be driven along rods 81 (in the lateral direction) so that tip 91 of blade 89 can cut paper product 13 along a linear path.

A wheel 93 is rotatably mounted onto the front surface of metal plate 87 beneath cutting block 85. Wheel 93 is disposed to roll in direct continuous contact against the top surface of platen 73. Preferably, wheel 93 is constructed of a high durometer rubber in order to impart a significant downward pressure onto platen 73.

It should be noted that the significant downward force applied by wheel 93 onto the top surface of platen 73 serves to effectively apply significant pressure onto both sides of paper product 13, thereby tightly sandwiching paper product 13 between platens 69 and 73 during the cutting process, which is highly desirable. As a result, paper product 13 is precluded from potentially wrinkling or bending during the severing process which, in turn, enables knife blade 89 to easily, accurately and effectively cut paper product 13, which is a principal feature of the present invention.

A first gear 95 is rotatably mounted on a bracket 97 which is fixedly secured onto the outer surface of bracket 29-2 by screws. Similarly, a second gear 99 is rotatably mounted on a bracket 101 which is fixedly secured onto the outer surface of bracket 29-1 by screws. A rubber belt 103 is wrapped around gears 95 and 99, gears 95 and 99 including peripherally extending teeth which are sized and shaped to grip corresponding notches (not shown) which are formed onto the inner surface of belt 103 along its length.

A bracket 105 is fixedly secured onto the rear surface of plate 87 of cutting device 83. Bracket 105 is sized and shaped to fixedly engage a portion of belt 103, thereby securing cutting device 83 onto belt 103.

A conventional 12 volt direct current (DC) motor 107 is fixedly secured to bracket 101, motor 107 being electrically connected to electronic circuitry 21. Motor 107 serves to rotatably drive second gear 99 in either the clockwise or counterclockwise direction, the particular direction in which gear 99 rotates to be controlled by circuitry 21. As a result, activation of motor 107 serves to rotatably drive gear 99 which, in turn, rotatably drives belt 103. The rotation of belt 103 slides cutting device 83 along rods 81 which, in turn, displaces cutting tip 91 of knife blade 89 along a linear path. It should be noted that, as knife blade 89, linearly travels, the front surface of knife blade 89 abuts against the rear edge of platen 69, thereby providing knife blade 89 with support during the linear cutting stroke, which is highly desirable.

As noted above, motor 107 is capable of driving second gear 99 in either the clockwise or counterclockwise. As a result, motor 107 can be used to drive knife blade 89 in either the right-to-left or left-to-right direction.

A horizontal tab 109 is fixedly secured onto the front surface of cutting block 85 by screws, as seen most clearly in FIG. 4. In addition, a pair of sensors 111-1 and 111-2 are secured onto brackets 29-1 and 29-2, respectively, each sensor 111 being electrically connected to circuitry 21 by wires. Tab 109 is disposed such that the linear displacement of cutting device 83 eventually causes tab 109 to pass within the detection zone of one of sensors 111. Once tab 109 is detected by an appropriate sensor 111, a corresponding signal is sent from the sensor 111 to electronic circuitry 21 to signify that the cutting stoke has completed.

Electronic circuitry 21 controls the operation of both feed mechanism 17 and cutting mechanism 19. Preferably, electronic circuitry 21 is electrically connected to a user-accessible computer for the system in which device 11 is being used. For example, if device 11 is used in conjunction with a label printing device, electronic circuitry 21 is preferably electrically connected to the computer system responsible for operating the label printing device.

Electronic circuitry 21 preferably includes a printed circuit board 113 which is mounted onto the front surface of vertical portion 37 of plate 33 by screws. (It should be noted that printed circuit board 113 is represented herein as being in the form of a rectangular board for simplicity purposes only). An application specific integrated circuit (ASIC), such as a microprocessor, is preferably mounted on circuit board 113 and serves as the central processing unit for electronic circuitry 21.

In use, device 11 can be used in the following manner to feed paper product 13 and, in turn, cut paper product 13 along a pre-defined linear path. Specifically, in the absence of paper product 13 being fed into device 11, first end 45-1 of finger 45 pivots down into slot 43 which, in turn, causes second end 45-2 of finger 45 to pass within the detection zone of sensor 49. In response thereto, sensor 49 sends a signal to electronic circuitry 21 which, in turn, preferably sends a signal to the computer system with which device 11 is being used that notifies the user to insert a supply of paper product 13 into device 11.

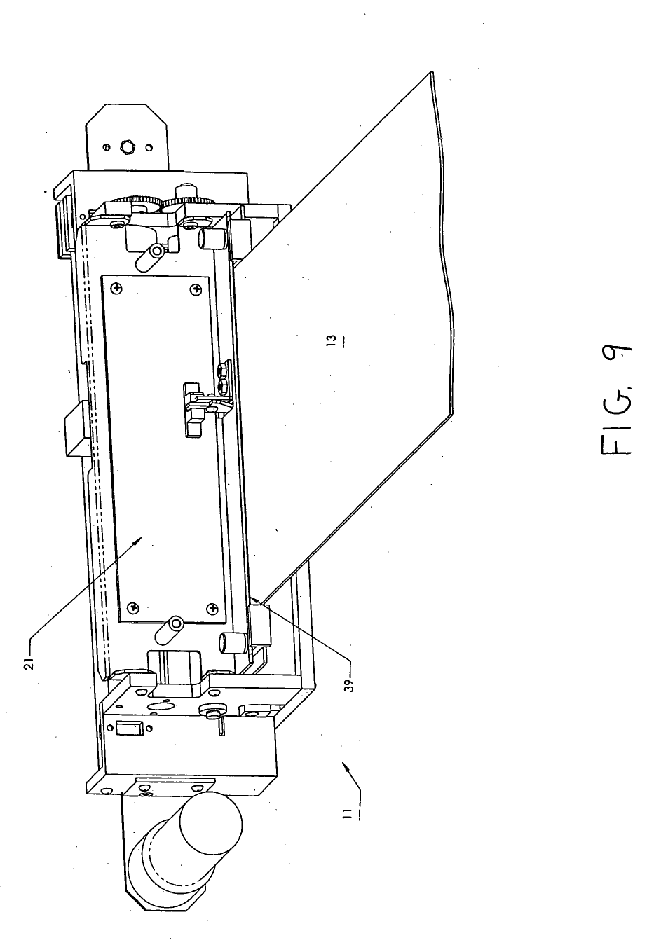

The consumer preferably inserts the leading edge 13-1 of paper product 13 in through paper entry channel 39, as shown in FIG. 9. As paper product 13 is being fed into paper entry channel 39, motor 57 is activated by electronic circuitry 21. The activation of motor 57 causes upper feed rollers 51 to rotate. With pressure being applied onto the underside of paper product 13 by lower feed roller 53, the activated upper feed rollers 51 serve to extract, or pull, paper product 13 into device 11 in the rearward direction. As noted briefly above, lower feed roller 53 can be displaced vertically downward so as to enable device 11 to extract thicker pieces of paper, which is highly desirable.

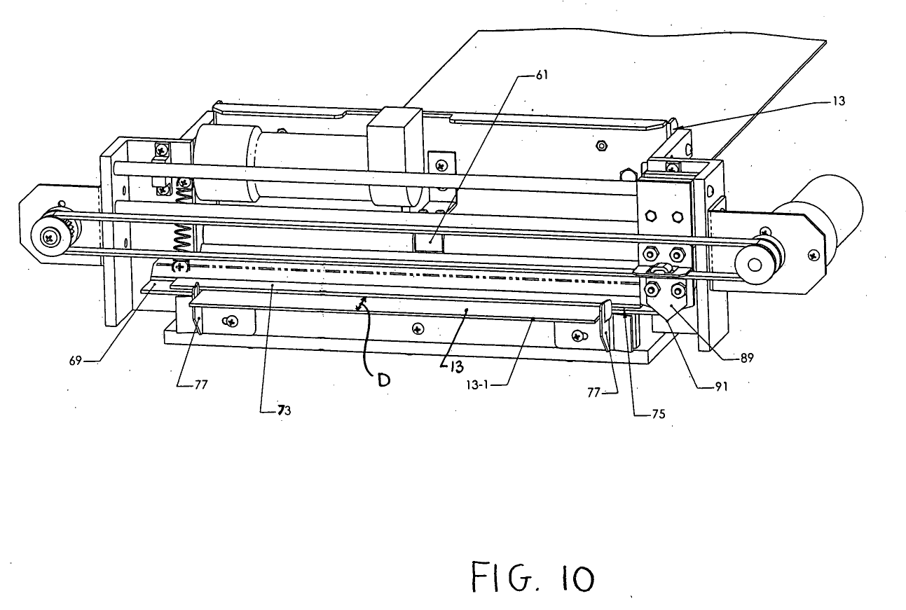

As upper feed rollers 51 pull paper product 13 rearward, eventually the leading edge 13-1 of paper product 13 passes within the detection zone of sensor 61. In response thereto, sensor 61 sends a signal to electronic circuitry 21. Preferably, the computer for the system in which device 11 is used allows for the consumer to specify the linear distance D in from the leading edge 13-1 of paper product 13 where cutting mechanism 19 is supposed to cut, distance D being shown in FIG. 10. Accordingly, based on the parameters established by the consumer using the computer, electronic circuitry 21 rotates upper feed rollers 51 at a particular speed and for a particular duration so that tip 91 of knife blade 89 is aligned precisely at the distance D in from the leading edge 13-1 of paper product 13 (as specified by the user), which is highly desirable.

Referring now to FIG. 10, as upper feed rollers 51 advance paper product 13, leading edge 13-1 of paper product 13 passes out through the narrow paper exit channel 75 between platens 69 and 73. As noted briefly above, platen 73 is spring biased away from platen 69 the necessary distance to enable paper product 13 to exit channel 75.

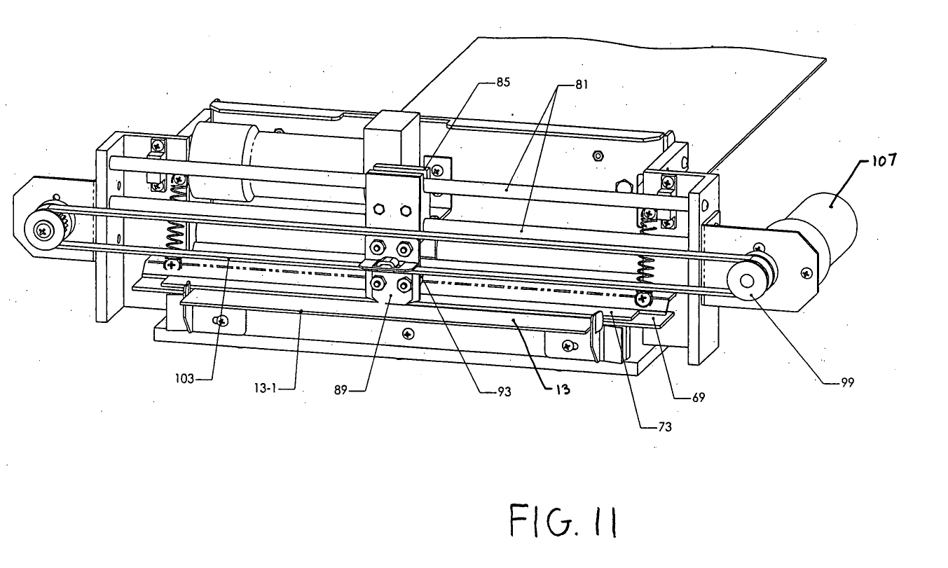

Once feed mechanism 17 has indexed paper product 13 such that the cutting tip 91 of knife blade 89 is aligned the user-specified distance in from the leading edge 13-1 of paper product 13, cutting mechanism 19 is activated. Specifically, as seen most clearly in FIG. 11, once electronic circuitry 21 completes feeding paper product 13 in place for subsequent severing, electronic circuitry 21 activates motor 107 in either the clockwise or counterclockwise direction (depending on the last position of cutting device 83 detected by sensors 111).

The activation of motor 107 rotates gear 99 which, in turn, rotatably drives belt 103. The rotation of belt 103 linearly slides cutting block 85 along rods 81. As cutting block 85 translates along rods 81, wheel 93 rolls on the top surface of platen 73 which, in turn, sandwiches paper product 13 tightly between platens 69 and 73, which is highly desirable. With paper product 13 held taut and secured in place by platens 69 and 73, displacement of cutting block 85 causes cutting tip 91 of knife blade 89 to cleanly cut paper product 13 along a linear path at the exact distance in from its leading edge which was previously specified by the user.

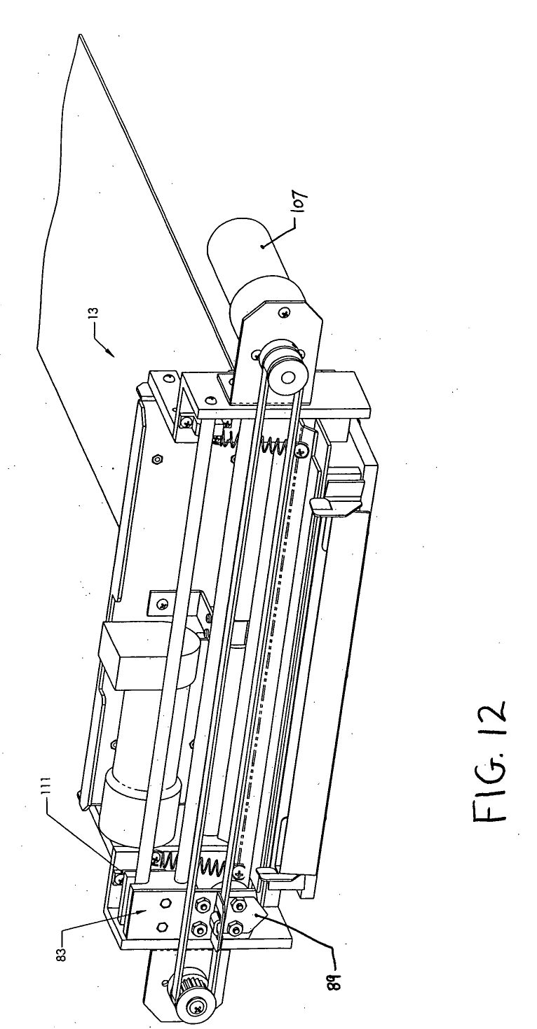

As seen most clearly in FIG. 12, once knife blade 89 completes its cutting stroke through paper product 13, the severed portion of paper product 13 is released from device 11. Upon completion of the cutting stroke, tab 109 on cutting device 83 passes within the detection zone of an appropriate sensor 111. In response thereto, sensor 111 sends a signal to electronic circuitry 21 which notifies circuitry 21 that the severing process has been completed. In turn, electronic circuitry 21 terminates activation of motor 107.

As can be appreciated, device 11 can repeat the aforementioned feeding and cutting process as desired, cutting device 83 preferably alternating directions along rods 81 for each cutting stroke.

The embodiment shown of the present invention is intended to be merely exemplary and those skilled in the art shall be able to make numerous variations and modifications to them without departing from the spirit of the present invention. All such variations and modifications are intended to be within the scope of the present invention as defined in the appended claims.

1. A device for feeding and cutting a product, said product having a top surface, a bottom surface and a leading edge, said device comprising:
(a) a feed mechanism for indexing said product, and
(b) a cutting mechanism for severing said product, said cutting mechanism comprising,
(i) a cutting device adapted to sever said product,
(ii) a first platen having a top surface and a bottom surface,
(iii) a second platen having a top surface and a bottom surface, said first platen and said second platen together defining a product exit channel therebetween.

2. The device as claimed in claim 1 wherein said cutting mechanism cuts said product along a linear path.

3. The device as claimed in claim 2 wherein said cutting mechanism cuts said product a user-specified distance in from its leading edge.

4. The device as claimed in claim 1 further comprising electronic circuitry for controlling the operation of said feed mechanism and said cutting mechanism.

5. The device as claimed in claim 1 further comprising a support on which said feed mechanism and said cutting mechanism are mounted.

6. The device as claimed in claim 2 wherein said cutting device is configured for linear displacement.

7. The device as claimed in claim 6 wherein said cutting device is slidably mounted along at least one horizontally disposed rod.

8. The device as claimed in claim 7 wherein said cutting device comprising a cutting block which is slidably mounted on the at least one horizontally disposed rod.

9. The device as claimed in claim 8 wherein said cutting device comprises a knife blade having a sharpened tip.

10. The device as claimed in claim 9 wherein said sharpened tip is V-shaped with two cutting edges.

11. The device as claimed in claim 6 wherein said cutting device comprises a rotatably mounted wheel which is disposed to roll along the top surface of said second platen.

12. The device as claimed in claim 11 wherein said wheel urges the bottom surface of said second platen into contact against the top surface of said product.

13. The device as claimed in claim 11 wherein said wheel serves to sandwich said product tightly between said first and second platens.

14. The device as claimed in claim 6 wherein said cutting device is linearly driven by a motor.

15. The device as claimed in claim 1 wherein said feed mechanism comprises:
(a) an upper feed roller, and
(b) a lower feed roller,
(c) wherein said upper and lower feed rollers are disposed to contact opposite sides of said product.

16. The device as claimed in claim 15 wherein said upper feed roller is rotatably driven by a motor.

17. The device as claimed in claim 16 wherein said lower feed roller is capable of vertical displacement relative to said upper feed roller.

18. The device as claimed in claim 17 wherein said lower feed roller is spring biased towards said upper feed roller.
